(19) United States
(12) Patent Application Publication
(10) Pub. No.: US 2008/0255941 A1
(43) Pub. Date: Oct. 16, 2008

(54) Method and system for generating, selecting, and running executables in a business system utilizing a combination of user defined rules and artificial intelligence

(76) Inventors: Jonathan Otto, Palm Beach, FL (US); Christine Amorossi, Bridgewater, CT (US); Michael R. Mueller, San Francisco, CA (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(21) Appl. No.: 11/983,679

(22) Filed: Nov. 9, 2007

Related U.S. Application Data
(63) Continuation-in-part of application No. 09/993,228, filed on Nov. 14, 2001.

(51) Int. Cl. G06Q 30/00; G06Q 99/00

(52) U.S. Cl. 705/14; 705/1

(57) ABSTRACT

A system including: a memory element of a specially programmed general-purpose computer storing a set of rules; a generating element in a processor for the computer using at least one genetic algorithm to generate a plurality of executables; a selecting element in the processor using the set of rules to select an executable from the plurality of executables; and an interface element in the computer outputting the executable. A system including: a generating element in a processor for a specially programmed general-purpose computer arranged to generate a marketing offer using a set of rules and at least one genetic algorithm and an interface element in the computer arranged to output the marketing offer. In some aspects, the generating element is arranged to: generate, using the at least one genetic algorithm, a plurality of marketing offers; and select, using the rules, the marketing offer from the plurality of marketing offers.

### CROSS-REFERENCE TO RELATED APPLICATIONS

This is a continuation-in-part patent application under 35 USC 120 of U.S. patent application Ser. No. 09/993,228, filed Nov. 14, 2001 and entitled “Method and apparatus for dynamic rule and/or offer generation,” which application is incorporation herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for generating and selecting executables in a business system. In particular, the invention relates to methods and systems for using artificial intelligence in combination with rules-based processing.

### BACKGROUND OF THE INVENTION

Systems to determine suggestive sell and cross marketing offers and upsells for a given transaction are known. Some such systems are table based while others are rules-bases, for example, a system administrator can enter rules into the system to define the nature of an offer to be offered to a customer. Other such systems use genetic algorithms and other artificial intelligence (AI) to learn the best offers to make to a customer. Both the rules-based and the AI systems can be improved. For example, a rules based system requires upkeep by a system administrator, adding to the cost of operating a rules-based system. On the other hand, an AI system can make undesirable offers as the systems attempts to optimize itself.

Thus, there is a long-felt need to provide a system combining the advantageous aspects of rules-based systems and AI systems. Specifically, a system that will provide a rules-based framework to guide the optimization of or otherwise constrain an AI system, without the upkeep associated with a rules-based system alone.

### SUMMARY OF THE INVENTION

The invention broadly comprises a system for operating a business system including: a memory element of a specially programmed general-purpose computer arranged to store a set of rules; a generating element in a processor for the general-purpose computer arranged to generate, using an artificial intelligence program, a plurality of executables; a selecting element in the processor arranged to select, using the set of rules, an executable from among the plurality of executables; and an interface element in the general-purpose computer arranged to output, using the processor, the executable. In some aspects, the interface element is arranged to output the executable for transmission to a communications device. In some aspects, the artificial intelligence program is at least one genetic algorithm.

The invention also broadly comprises a system for managing sales and marketing promotions, including: a generating element in a processor for a specially programmed general-purpose computer arranged to generate a marketing offer using a set of rules, an artificial intelligence program and at least one memory element in the general-purpose computer; and an interface element in the general-purpose computer arranged to output the marketing offer. In some aspects, the artificial intelligence program is at least one genetic algorithm and the generating element is arranged to: generate, using the at least one genetic algorithm, a plurality of marketing offers; and select, using the rules, the marketing offer from the plurality of marketing offers and the interface element is arranged to output the marketing offer for transmission to a communications device.

In some aspects, the artificial intelligence program is at least one genetic algorithm and the generating element is arranged to: generate, using the set of rules, a plurality of marketing offers; and select, using the at least one genetic algorithm, the marketing offer from the plurality of marketing offers, and the interface element is arranged to output the marketing offer for transmission to a communications device. In some aspects, the artificial intelligence program is at least one first and second genetic algorithms and the generating element is arranged to: define a set of rules using the at least one first genetic algorithm; select, using the at least one second genetic algorithm, a plurality of marketing offers; and select, using the set of rules, the marketing offer and the interface element is arranged to output the marketing offer for transmission to a communications device.

In some aspects, the artificial intelligence program is at least one first and second genetic algorithms the generating element is arranged to: generate, using the at least one first genetic algorithm, a first plurality of marketing offers; select, using the set of rules, a second plurality of marketing offers from the first plurality of marketing offers; and select, using the at least one second genetic algorithm, the marketing offer. In some aspects, the artificial intelligence program is at least one genetic algorithm, the at least one memory element is arranged to store first and second sets of rules, and the generating element is arranged to: generate, using the first set of rules, a first plurality of marketing offers; select, using the at least one genetic algorithm, a second plurality of marketing offers from the first plurality of marketing offers; and select, using the second set of rules, the marketing offer.

In some aspects, the interface element is arranged to accept an order for an item and the generating element is arranged to generate the marketing offer in response to the order. In some aspects, the system includes a compiler element in the processor arranged to store in the at least one memory element, a history of sales transactions by at least one of a customer, store, area, region, grouping of transaction types, and class of transaction types and the interface element is arranged to accepting an input associated with the at least one of a customer, store, area, region, grouping of transaction types, and class of transaction types and the generating element is arranged to generate the marketing offer in response to the history of sales transactions or the input.

In some aspects, the generating element is arranged to generate the marketing offer in response to at least one of temporal information, personnel involved with the offer, a location associated with the offer, a weather condition, sales information associated with the offer, inventory information, a marketing or promotional campaign, change amount due, a method of payment, an available discount, a response to a previous offer, a response a previous offer to a given customer, type of customer, and class of customer. In some aspects, the generating element is arranged to select content of the marketing offer and a sensory presentation for the offer.

The invention further broadly comprises a system including: an interface element for a specially programmed general-purpose computer arranged to receive an order; and a determining element in a processor for the general-purpose computer arranged to determine an offer, using an artificial intelligence program and a set of rules stored in a memory element in the general-purpose computer, based on information included in the order. In some aspects, the artificial intelligence program is at least one genetic algorithm and the determining element is arranged to generate, using the at least one genetic algorithm, a plurality of offers and select, using the rules, the offer from the plurality of offers and wherein the interface element is arranged to output the offer for transmission to a communications device. In some aspects, the artificial intelligence program is at least one genetic algorithm and the determining element is arranged to generate, using the set of rules, a plurality of offers and select, using the at least one genetic algorithm, the offer from the plurality of marketing offers and the interface element is arranged to output the offer for transmission to a communications device.

The invention also broadly comprises methods for operating a business system and for managing sales and marketing promotions.

It is a general object of the present invention to provide systems and methods to generate optimal executables for use by a business system.

It is another object of the present invention to provide systems and methods that combine rules-based processing with artificial intelligence to optimize the generation and selection of executables for use by a business system.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for operating a business system;

FIG. 2 is a schematic block diagram of a present invention system for managing sales and marketing promotions;

FIG. 3 is a schematic block diagram of a present invention system;

FIG. 4 is a flow chart of a present invention method for operating a business system;

FIG. 5 is a flow chart of a present invention method for managing sales and marketing promotions; and,

FIG. 6 is a flow chart of a present invention method.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp” target=“_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

A present invention system and method generate at least one respective executable using a respective artificial intelligence program (AIP) and one or both of a respective genetic program and a respective genetic algorithm. The operation of a genetic program and a genetic algorithm are described in U.S. patent application Ser. No. 09/993,228, filed Nov. 14, 2001 and entitled “Method and apparatus for dynamic rule and/or offer generation,” which is incorporated herein by reference. That is, the present invention includes a method and system for integrating a rules-bases (RB) business system with a business system based on artificial intelligence (AI). In general, the present invention is applicable to any business process that is managed by an RB system or by an AI system. A present invention system improves on the design and operation of previous RB systems and previous AI systems by combining the most advantageous practices of the RB and AI systems. For example, a present invention system combines the advantageous framework provided by a RB system with the flexibility and adaptability of an AI system.

Further, the AI component determines optimal executables on an ongoing basis without selecting absurd, or unrealistic, or otherwise undesirable executables that could be counter-productive. For example, in some aspects, the executables are regarding items to include in offers for sale by a commercial enterprise encompassing the business system and a present invention system and method avoids making offers to customers that could upset the customers or be counter to such commercial enterprise's financial or other objectives.

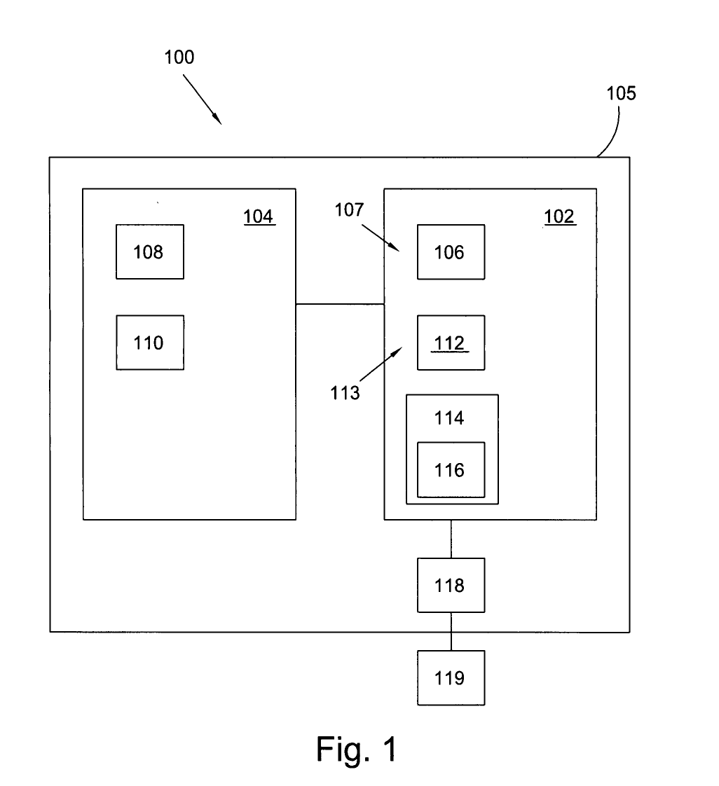

FIG. 1 is a schematic block diagram of present invention system 100 for operating a business system (not shown). System 100 includes memory element 102 and processor 104 in specially programmed general-purpose computer 105. Element 102 is arranged to store set 106 of rules, which form at least part of an RB portion 107 of system 100. Rules 106 can be generated by any means known in the art. In some aspects, the rules are formulated by a person, for example, a person in a managerial role and input to computer 105 using any means known in the art. Processor 104 includes generating element, or function, 108 and selecting element, or function, 110. Alternately stated, elements 104 and 108 and any other elements described as being in the processor are functions of the processor or are functions carried out by the processor. Element 108 is arranged to generate, using artificial intelligence program 112, which forms at least part of an AI portion 113 of system 100 and which is stored in memory element 102, plurality 114 of executables. The selecting element is arranged to select, using set 104, executable 116 from the plurality of executables. System 100 also is arranged to execute executable 116. For example, in some aspects, the system includes interface element 118 in computer 105 arranged to output executable 116. By interface element, we mean any combination of hardware, firmware, or software in a computer used to enable communication or data transfer between the computer and a device, system, or network external to the computer, for example, network 119. The interface element can connect with the device, system, or network external to the computer using any means known in the art, including, but not limited to a hardwire connection, an optical connection, an Internet connection, or a radio frequency connection. In the figures, a non-limiting example, of a hardwire connection is shown. In some aspects, the interface element is arranged to output executable 116 for transmission to a communications device (not shown). Computer 105 can be any computer or combination of computers known in the art. Memory element 102, processor 104, and interface element 118 can be any memory element, processor, or interface element, respectively, or combination thereof, known in the art. Artificial intelligence program 112 can be any artificial intelligence program known in the art. In some aspects, program 112 is a genetic program or includes one or more genetic algorithms.

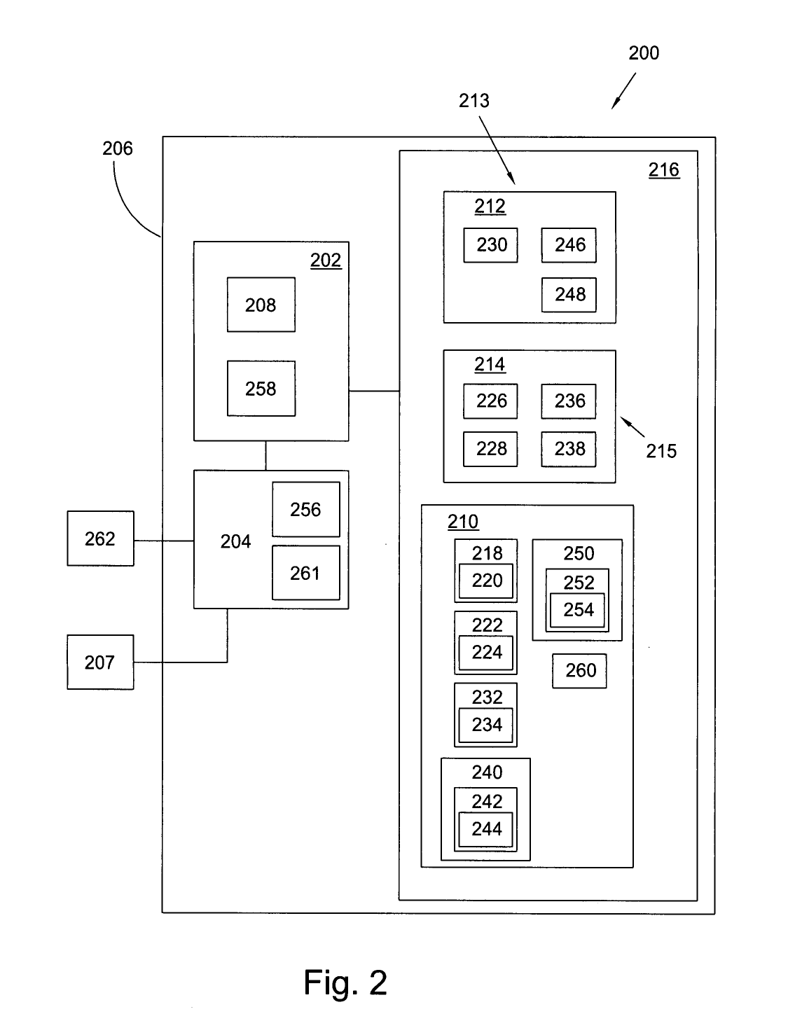

FIG. 2 is a schematic block diagram of present invention system 200 for managing sales and marketing promotions. System 200 includes processor 202 and interface element 204 in specially programmed general-purpose computer 206. By interface element, we mean any combination of hardware, firmware, or software in a computer used to enable communication or data transfer between the computer and a device, system, or network external to the computer, for example, network 207. The interface element can connect with the device, system, or network external to the computer using any means known in the art, including, but not limited to a hardwire connection, an optical connection, an Internet connection, or a radio frequency connection. In the figures, a non-limiting example, of a hardwire connection is shown. Processor 202 includes generating element, or function, 208 arranged to generate marketing offer 210 using set 212 of rules, which form at least part of an RB portion 213 of system 200, and artificial intelligence program 214, which forms at least part of an AI portion 215 of system 200. In some aspects, the set of rules and the artificial intelligence program are stored in at least one memory element 216 in computer 206. Artificial intelligence program 214 can be any artificial intelligence program known in the art. In some aspects, program 214 is a genetic program or includes one or more genetic algorithms. In the description that follows, one or more genetic algorithms are used for the artificial intelligence program, however, it should be understood that this is a non-limiting example only. The interface element is arranged to output the marketing offer to network 207. In some aspects, the network is arranged to transmit the offer to any network device known in the art. Computer 206 can be any computer or combination of computers known in the art. Memory element 216, processor 202, and interface element 204 can be any memory element, processor, or interface element, respectively, or combination thereof, known in the art.

In some embodiments, element 208 is arranged to generate, using algorithm 214, plurality 218 of marketing offers and to select, using rules 212 marketing offer 220 from plurality 218 of marketing offers. In some aspects, plurality 218 and offer 220 are stored in element 216. Thus, an AI function is used to generate a pool of perspective offers and an RB function is used to filter the pool, or select one or more suitable offers from the pool generated by the AI function. As an example, in a restaurant setting, rules 212 could be used to screen out food offers that may be plausible according to the AI function, for example, a repeat offer for an item included in an initial order, but may be deemed by a manager of the restaurant to be undesirable to a majority of customers. By offer, we mean an opportunity to engage in a commercial transaction with an entity employing system 200. For example, the entity can be a retail commercial enterprise and offers can be offers to potential customers to purchase items from the enterprise.

In some embodiments, the generating element is arranged to generate, using rules 212, plurality 222 of marketing offers and to select, using genetic algorithm 214, marketing offer 224 from plurality 222 of marketing offers. In some aspects, plurality 222 and offer 224 are stored in element 216. In some aspects, the interface element is arranged to output the marketing offer for transmission to a communications device (not shown). Thus, an RB function is used to generate a pool of perspective offers and an AI function is used to filter the pool, or select one or more suitable offers from the pool generated by the RB function. As an example, in a restaurant setting, algorithms 214 could be used to select an optimal food offer from a pool of offers selected by rules, which were designed by a manager of the restaurant to exclude offers deemed to be undesirable in specific situations.

In some embodiments, algorithms 214 include at least one respective algorithm 226 and 228. Then, the generating element is arranged to define set 230 of rules using algorithm 226, to select, using algorithm 228, plurality 232 of marketing offers and to select, using rules 230, marketing offer 234. In some aspects, plurality 232 and offer 234 are stored in element 216. Thus, an AI function is used to generate a pool of perspective offers and an RB function is used to filter the pool, or select one or more suitable offers from the pool generated by the AI function. However, in addition, an AI function is used to generate the rules, adding additional flexibility and automation to the process, that is, operator input, such as from an administrator is no longer needed to provide the RB portion of the system.

In some embodiments, algorithms 214 include at least one respective algorithm 236 and 238. Then, the generating element is arranged to: generate, using algorithm 236, plurality 240 of marketing offers; select, using rules 212, plurality 242 of marketing offers from plurality 240; and select, using algorithm 238, marketing offer 244.

In some embodiments, the memory element is arranged to store sets 246 and 248 of rules and the generating element is arranged to: generate, using rules 246, a plurality 250 of marketing offers; select, using algorithm 214, a plurality 252 of marketing offers from plurality 250; and select, using rules 248, marketing offer 254.

System 200 can execute an offer using any means known in the art. In some aspects, the interface element is arranged to output the marketing offer for transmission to a communications device (not shown).

In some embodiments, the interface element is arranged to accept order 256 for an item (not shown) and the generating element is arranged to generate marketing offer 210 in response to the order. In some embodiments, processor 202 includes compiler element, or function, 258 arranged to store in the memory element, history 260 of sales transactions by at least one of (not shown) a customer, store, area, region, grouping of transaction types, and class of transaction types, wherein the interface element is arranged to accept input 261 associated with said at least one of a customer, store, area, region, grouping of transaction types, and class of transaction types. The data for the history can be gathered and compiled using any means known in the art. Then, the generating element is arranged to generate marketing offer 210 in response to the history of sales transactions.

Thus, system 200 outputs offers, receives responses to the offers, and adapts the generation of further offers to the responses received for other or previous offers. For example, the system can determine the success garnered by earlier offers and adapt the offer generation process to favor more successful previous offers. In some aspects such adaptation includes consideration or use of various available information, including, for example, the entity's (e.g., a customer's) prior buying habits and/or acceptance or rejection of offers under generally the same or similar circumstances. Such circumstance include, but are not limited to the time or day or day of the week when the order is placed, order contents, purchase location, method of ordering, e.g., at a POS terminal vs. a kiosk location vs. cell phone, destination of order, e.g., drive through vs. front counter vs. home delivery, total order amount, number of items in the order, method of payment, change amount due, number of customers in the party or transaction, customer demographic information, e.g., personal or household income, or any other available information regarding or relating to any past or current transactions and/or information relating to the selling or purchasing entity, including, for example, inventory information, local, regional or national sales campaigns, new product introductions, supply constraints or oversupply, customer buying trends, prices, including changes in prices or expected changes, and/or competitive information.

In some embodiments, the generating element is arranged to generate marketing offer 210 in response to at least one of (not shown) temporal information, personnel involved with said offer, a location associated with said offer, a weather condition, sales information associated with said offer, inventory information, a marketing or promotional campaign, change amount due, a method of payment, an available discount, a response to a previous offer, a response a previous offer to a given customer, type of customer, and class of customer. The preceding data and factors can be gathered using any means known in the art.

In some embodiments, the generating element is arranged to select a content of marketing offer 210 and a sensory presentation for the offer. That is, element 208 selects the structure of the offer and how the offer is to be presented. An offer can be formatted for any type of sensory presentation known in the art and transmitted to enterprise and/or customer devices for such presentation. For example, the presentation can be graphical and/or audio. In some aspects, an offer is transmitted to graphical user interface (GUI) 262 associated with an enterprise or customer device and is graphically and audibly presented on the GUI.

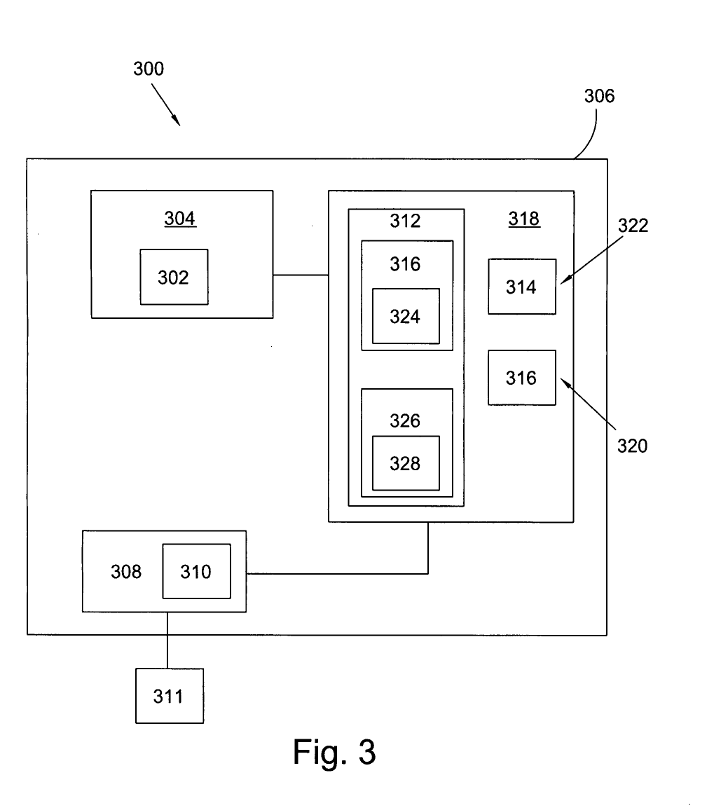

FIG. 3 is a schematic block diagram of present invention system 300. System 300 includes determining element, or function, 302 in processor 304 of specially programmed general-purpose computer 306. System 300 also includes interface element 308 arranged to receive order 310. By interface element, we mean any combination of hardware, firmware, or software in a computer used to enable communication or data transfer between the computer and a device, system, or network external to the computer, for example, network 311. The interface element can connect with the device, system, or network external to the computer using any means known in the art, including, but not limited to a hardwire connection, an optical connection, an Internet connection, or a radio frequency connection. Element 302 is arranged to determine offer 312, using artificial intelligence program 314 and set 316 of rules, stored in memory element 318 of computer 306, based on information included in the order. That is, the order initiates the process of selecting offer 312, or alternately stated, the offer is responsive to the order.

Rules 316 form at least part of an RB portion 320 of system 300 and artificial intelligence program 314 forms at least part of an AI portion 322 of system 300. Artificial intelligence program 314 can be any artificial intelligence program known in the art. In some aspects, program 314 is a genetic program or includes one or more genetic algorithms. In the description that follows, one or more genetic algorithms are used for the artificial intelligence program, however, it should be understood that this is a non-limiting example only.

In some embodiments, the determining element is arranged to generate, using the genetic algorithm, plurality 316 of offers and select, using the rules, offer 324 from plurality 316 of offers. In some embodiments, the determining element is arranged to generate, using the rules, plurality 326 of offers and select, using the algorithms, offer 328 from plurality 326 of offers. In some embodiments, the interface element is arranged to output offer 312 to network 311 for transmission to a communications device (not shown).

The following should be viewed in light of FIGS. 1 through 3. Portions of the following discussion references system 200, however, it should be understood that these portions are applicable to any present invention system, including systems 100 and 300. In the discussion supra, system 200 produces a variety of intermediate pluralities of prospective offers and a variety of ‘final’ offers, such as offer 210. It should be understood that any or all of the pluralities may be the same, may have some common elements, or may have no elements in common. For example, plurality 218 (generated by AI functionality) and plurality 222 (produced by RB functionality) could include the same prospective offers, some of the same prospective offers, or be mutually exclusive. Thus, the offer selected from the pluralities, offers 220 and 224, respectively, could be the same or different. It also should be understood that system 200 is not limited to a single ‘final’ offer, such as offer 220, and that a final offer can be part of a plurality of offers.

It should be understood that system 200 is not limited to a particular number of nodes or steps of processing and filtering by AI and RB functionality. For example, in the above aspects, two or three nodes are used, but it should be understood that other numbers of nodes can be used. In one of the three node aspects, AI functionality is used to generate a pool of offers, RB functionality is used to filter the pool, and AI functionality is used to select the final offer(s). In the other three node aspect, RB functionality is used to generate a pool of offers, AI functionality is used to filter the pool, and RB functionality is used to select the final offer(s). Further, although alternating AI and RB functionalities are described supra, it should be understood that any combination and sequence of AI and RB functionality is included in the spirit and scope of the claimed invention.

It should be understood that systems 100 through 300 can be used in any business system known in the art in which executables or offers are generated, selected, and executed. By executable we mean any process or function that is incorporated in or part of the operation of the business system. For example, in some aspects, the business system is part of a commercial enterprise. Then, for example, executables can be offers generated by the business system regarding items offered for sale by the enterprise, or executables can be purchasing orders regarding the acquisition of the items sold by the enterprise or used by the enterprise. Thus, a present invention system is applicable to any business system in which multiple data paths are considered in order to choose a course of action.

A present invention system can output an executable or offer to any network or Internet-enabled device (IED) known in the art, including, but not limited to a point of sale (POS) terminal, digital signage, or kiosk at a location associated with a commercial enterprise using the system, for example, at a retail outlet (hereinafter, such devices are referred to as enterprise devices). The IED also can be associated with a party transacting with an entity using the system, for example, a customer of the entity rather than with the commercial enterprise (hereinafter, such devices are referred to as customer devices). That is, a customer device is owned by, used by, or otherwise in the possession of the party. Examples of customer devices include, but are not limited to, a wireless communications device, such as cellular telephone or a PDA, or a computer, e.g., a laptop. Thus, in some aspects, a present invention system extends offers to one or both of enterprise and customer devices.

Any type of interactive functionality known in the art can be implemented in the enterprise and customer devices. For example, touch screen, keypad, and audio commands can be enabled by a present invention system in accordance with the functionality and configuration of the respective enterprise and customer devices. For example, if system 200 is used in a retail enterprise, the content of the offer could include items to offer for sale and prices of the item(s). The sensory presentation could be how the offer is displayed, for example, on a graphical user interface (GUI) at a POS terminal. For example, the size, color, and visual intensity, as well as the audio aspects of the displayed offer can be selected and dynamically modified to optimize the offer.

Advantageously, the respective AI portions of systems 100 through 300 enable present invention systems to be adaptive and responsive to previous and current actions and conditions. That is, the AI portions add an adaptive aspect to supplement the more linear structure of the respective RB portions. For example, system 200 could be used to generate one or more offers for sale of items sold by a retail operation. The system can receive responses to the offers and the AI portion can automatically track the responses to the offers, for example, the AI portion can compile the responses, and analyzes the compiled responses. In particular, the AI portion can analyze the responses to better identify optimal current and future offers. For example, if multiple offers are made under a specific set of conditions, the AI portion can note which of the offers has the highest acceptance rates under these conditions. Then, when the set of conditions arise, the AI portion can generate or select with greater frequency the offers that had been noted as having the higher acceptance rates. That is, the AI portion enables a present invention system to automatically adapt to actual conditions and modify executables or offers accordingly, rather than waiting for a system administrator to modify the RB portion.

Equally advantageously, a present invention system can use the RB portion as a ‘reality check’ with respect to the AI portion. That is, the RB portion allows human interaction based on factors not accessible to the AI portion.

The following is a non-limiting example of system 200 in the context of a quick service food establishment such as McDonald's. The following example uses the two node aspect of algorithm 214 generating a plurality of potential offers from which an offer is selected using rule 214. However, it should be understood that the discussion below is applicable to other embodiments of system 200. The AI portion, for example, algorithms 212, defines a pool, or plurality, of items that can be offered to a customer based on the customer's transaction, that is, the AI portion defines a pool of executables. The pool of items includes the items that are deemed generally most logical, desirable or plausible given the items included in the customer's transaction and/or other prior purchase information. For example, if the customer orders a hamburger, French fries, and a small cola drink, the AI portion provides for the following upsell offers (executables), given the items in the customer's order: a salad; an upsell to a large cola; a shake; and/or a cookie. In some aspects, the AI portion includes items that are not to be offered as part of an upsell, given the items in a customer order. For example, for the order noted above, the AI portion could exclude the following items: a hamburger; French fries; and a small cola. In this example, the AI portion excluded offering the same items included in the original customer order. However, it should be understood that other criteria can be used to determine items to be excluded in an upsell offer. For example, breakfast items could be excluded as upsells for a customer order placed after 1 PM. Then, the RB portion selects items to offer the customer from the pool generated by the AI portion.

In some aspects, the AI portion might determine that, given the initial order in the preceding example, certain customers may actually accept additional or repetitive items, e.g., an additional hamburger, but the enterprise may decide that such offers may offend a certain population of its customers and therefore, choose to omit or preclude such offers so as not to offend said population of customers, even though making such offers might result in additional sales and profits. In this fashion, the present invention permits end users, e.g., enterprise management to impose rules or constraints, via the RB portion, on an otherwise unconstrained or adaptive system whose objective is to optimize certain results while unable to consider certain non-empirical or other information or preferences (such as customer sensibilities).

Once the system uses the AI portion to determine a pool of potential offers, the RB portion is applied to the pool to determine the best or generally more favorable or optimal item(s) to offer for the upsell and the upsell offer or offers is/are presented to the customer. The customer accepts or declines the offer(s), and the system stores the result to further refine the AI aspect. For example, if the system notes that given the initial customer order noted above, a customer accepts the salad 80 percent of the time and declines the milkshake 80 percent of the time, the AI portion can choose to highlight the offer or make such salad offer more frequently and de-emphasize or cease making the offer of the milkshake so as to present the most appealing offer to the customer.

In addition or in the alternate, the system might make new or different offers in an effort to find other generally acceptable or desirable offers for a given customer or based upon a given order contents or other available information. By making such new or different offers, the disclosed system provides a means of adaptation. In certain aspects such adaptation includes consideration or use of various available information, including, for example, the entity's (e.g., a customer's) prior buying habits and/or acceptance or rejection of offers under generally the same or similar circumstances, e.g., the time or day or day of the week when the order is placed, order contents, purchase location, method of ordering, e.g., at a POS terminal vs. a kiosk location vs. cell phone, destination of order, e.g., drive through vs. front counter vs. home delivery, total order amount, number of items in the order, method of payment, change amount due, number of customers in the party or transaction, customer demographic information, e.g., personal or household income, or any other available information regarding or relating to any past or current transactions and/or information relating to the selling or purchasing entity, including, for example, inventory information, local, regional or national sales campaigns, new product introductions, supply constraints or oversupply, customer buying trends, prices, including changes in prices or expected changes, and/or competitive information.

In some aspects, for a retail application of a present invention system involving a transaction, or order, one or more of the following elements are considered by the system, in addition to items that may be included in the transaction, for determining upsells to offer with regard to the transaction: a customer identified during a transaction, the customer's purchase history, for example, the proclivity of the customer to accept or reject upsell offers in general or certain upsell offers in particular; temporal information, for example, the time of day or day of the week, and the affects of the temporal information on upsell acceptance; the cashier involved in the transaction, for example, selecting upsells that historically do best with the cashier; location where the offer was placed (drive thru, counter, kiosk, website), for example, integrating upsell acceptance trends based on the location into the upsell offer; current or predicted weather and historical affects of weather conditions on upsell offers; current store volume in sales or transaction count, or rate of speed of service; current inventory levels, for example, emphasizing upsell offers for items available in the greatest quantities; local, regional or national current marketing or promotional campaigns; change amount due, for example, aligning the cost of an upsell offer to match the amount of change due; method of payment; presence or absence of any other discounts in the order; and prior acceptance or rejection of a previous offer, for example, adding additional upsells to an accepted upsell or avoiding additional upsells after an initial rejection of a first upsell offer.

A present invention system can be implemented by any combination of hardware, firmware, or software known in the art. In some aspects, a combination of the following hardware devices is used to implement and run the System: POS device, such as a computerized cash register; an Upsell Server; a Back Office Server; a Central Server; and an Upsell Output Device. The selection of devices from among those listed above is influenced by factors including, but not limited to: overall network or computer infrastructure for an organization using the System; degree of local and central control inherent in the organization; and format at the point of sale. For example, in some aspects, each location of an organization includes a computerized POS systems linked to a central headquarters or other processing location(s), e.g., a server farm or co-location facility. In this case, the initialization of the System, for example, inputting the Rules, the generation of offers, the presentation of offers, and the collection of data regarding customer responses to offers may all be performed by a single server at the central headquarters.

In some aspects, each location of an organization includes a computerized POS system that is partially locally controlled and still linked to a central headquarters. In this case, the initialization of a present invention system, for example, inputting information to configure the RB or AI subsystem may be performed using a centralized server at the headquarters location, which then provides, for example, the pool of executables, to the various locations. Then, regional or local servers generate offers, present offers, and collect data regarding customer responses to offers. Data collected by the regional or local servers is shared with the central server as desired or required. In some aspects, a POS may include an integrated interface that combines retail functions and display functions. In some aspects, a POS may include a separated cash register and a separate display device. It should be understood that a present invention system is not limited to the configurations discussed above and that other configurations are within the spirit and scope of the invention as claimed and are well known in the industry by those of ordinary skill in the art.

In some aspects, various databases are used in conjunction with the RB and AI aspects of a present invention system to determine and select executables: Cashier Databases including Cashier ID, Cashier Name, Cashier Start Date, Cashier Commission, or Cashier Score; Transaction Database including Transaction ID, Item ID, Subtotal, Taxes, or Total; Inventory Database including Item ID, Item Name, or Item Price; Customer Database including Customer Name, Transaction ID, Payment Identifier, or Phone Number; Upsell Event Type Database including Event Type ID, Event Type Descriptor, Event Type Locations, Event Type Employees, or Event Type Times; Upsell Event Rules Database including Rule ID, Rule Descriptor, or Rule Condition(s); Upsell Offer Database including Upsell ID, Upsell Descriptor, Upsell Price, or Upsell conditions; Upsell Rules Database including Rule ID, Rule Descriptor, or Rule Condition(s).

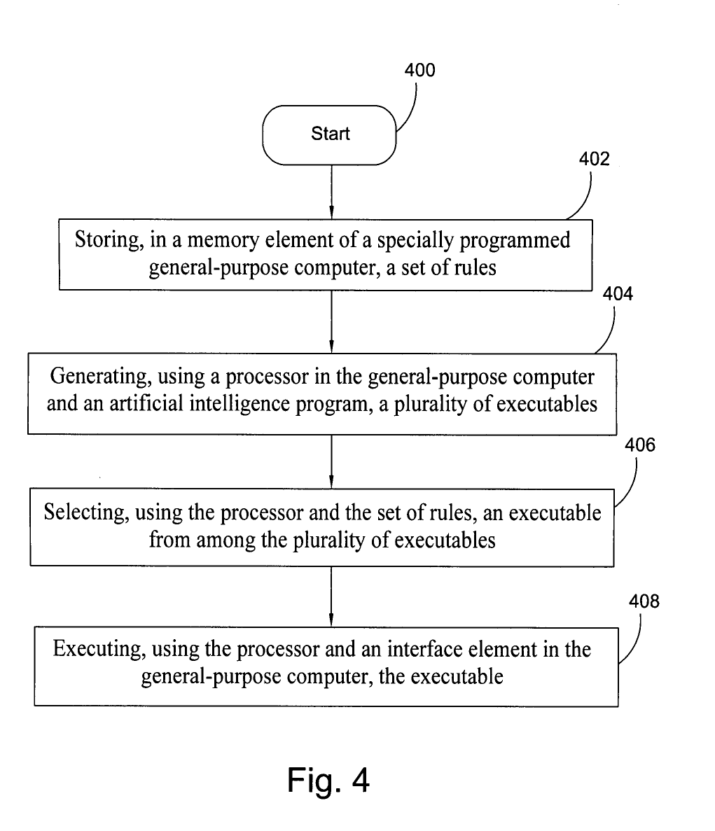

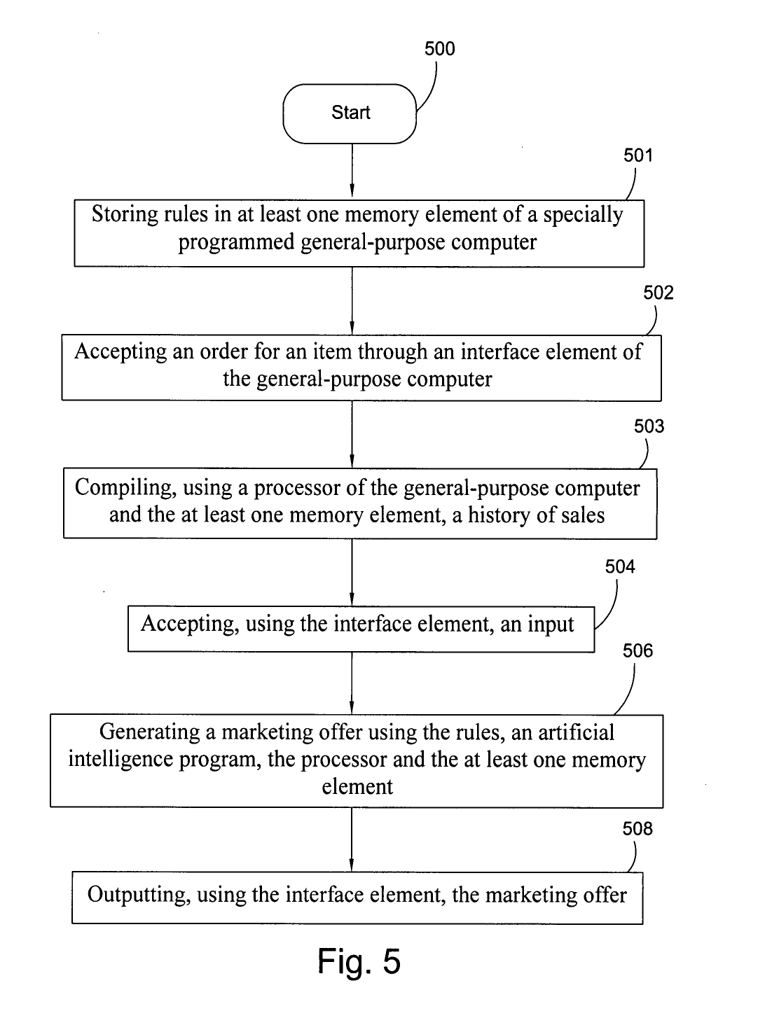

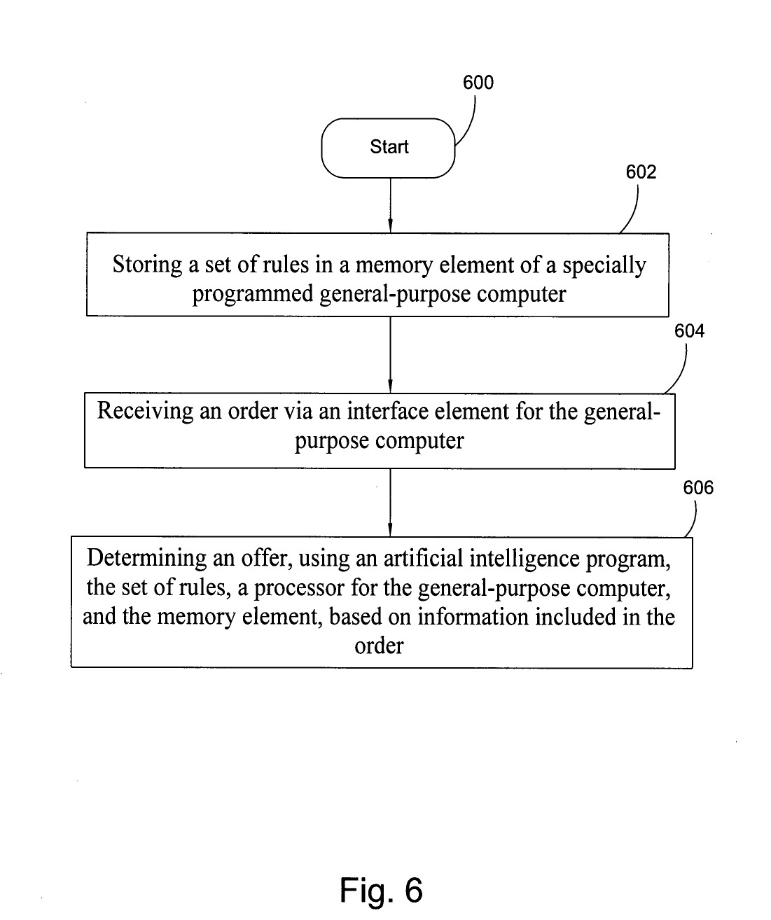

FIG. 4 is a flow chart illustrating a present invention method for operating a business system. Although the method in FIG. 4 (and FIGS. 5 and 6 below) is depicted as a sequence of numbered steps for clarity, no order should be inferred from the numbering unless explicitly stated. The method starts at Step 400. Step 402 stores, in a memory element of a specially programmed general-purpose computer, a set of rules. Step 404 generates, using a processor in the general-purpose computer and an artificial intelligence program, a plurality of executables. Step 406 selects, using the processor and the set of rules, an executable from among the plurality of executables. Step 408 executes, using the processor and an interface element in the general-purpose computer, the executable.

In some aspects, step 408 outputs the executable for transmission to a communications device, or the artificial intelligence program comprises at least one genetic algorithm.

FIG. 5 is a flow chart illustrating a present invention method for managing sales and marketing promotions. The method starts at step 500. Step 506 generates a marketing offer using a set of rules, an artificial intelligence program, and a processor and at least one memory element in a specially programmed general-purpose computer. Step 508 outputs, using an interface element in the general-purpose computer, the marketing offer.

In some aspects, the artificial intelligence program includes at least one genetic algorithm, step 501 stores, in the at least one memory element, the set of rules and step 506: generates, using the processor and the at least one genetic algorithm, a plurality of marketing offers and selects, using the set of rules and the processor, the marketing offer from the plurality of marketing offers and step 508 outputs the marketing offer for transmission to a communications device.

In some aspects, the artificial intelligence program includes at least one genetic algorithm, step 501 stores, in the at least one memory element, the set of rules and step 506: generates, using the set of rules and the processor, a plurality of marketing offers and selects, using the at least one genetic algorithm and the processor, the marketing offer from the plurality of marketing offers and step 508 outputs the marketing offer for transmission to a communications device.

In some aspects, the artificial intelligence program includes at least one first and second genetic algorithms and step 506: defines a set of rules using the at least one first genetic algorithm and the processor; selects, using the at least one second genetic algorithm and the processor, a plurality of marketing offers; and selects, using the set of rules and the processor, the marketing offer and step 508 outputs the marketing offer for transmission to a communications device.

In some aspects, the artificial intelligence program includes at least one first and second genetic algorithms, step 501 stores, in the at least one memory element, the set of rules and step 506: generates, using the at least one first genetic algorithm and the processor, a first plurality of marketing offers; selects, using the set of rules and the processor, a second plurality of marketing offers from the first plurality of marketing offers; and selects, using the at least one second genetic algorithm and the processor, the marketing offer.

In some aspects, the artificial intelligence program includes at least one genetic algorithm, step 501 stores first and second sets of rules and step 506: generates, using the first set of rules and the processor, a first plurality of marketing offers; selects, using the at least one genetic algorithm and the processor, a second plurality of marketing offers from the first plurality of marketing offers; and selects, using the second set of rules and the processor, the marketing offer.

In some aspects, step 502 accepts an order for an item through the interface element and step 506 generates the marketing offer in response to the order. In some aspects, step 503 compiles, using the processor and the at least one memory element, a history of sales transactions by at least one of a customer, store, area, region, grouping of transaction types, and class of transaction types and step 504 accepts, using the interface element, an input associated with the at least one of a customer, store, area, region, grouping of transaction types, and class of transaction types and step 506 generates a marketing offer in response to the history of sales transactions or the input.

In some aspects, step 506 generates the marketing offer in response to at least one of temporal information, personnel involved with the offer, a location associated with the offer, a weather condition, sales information associated with the offer, inventory information, a marketing or promotional campaign, change amount due, a method of payment, an available discount, a response to a previous offer, a response a previous offer to a given customer, type of customer, and class of customer. In some aspects, step 506 selects a content of the marketing offer and a sensory presentation for the offer.

FIG. 6 is a flow chart illustrating a present invention method. The method starts at step 600. Step 604 receives an order via an interface element for a specially programmed general-purpose computer and step 606 determines an offer, using an artificial intelligence program, a set of rules, and a processor and memory element in the general-purpose computer, based on information included in the order. In some aspects, the artificial intelligence program comprises at least one genetic algorithm and step 602 stores the set of rules in the memory element and step 604 generates, using the at least one genetic algorithm and the processor, a plurality of offers and selects, using the rules and the processor, the offer from the plurality of offers. In some aspects, step 606 outputs, via an interface element for the general-purpose computer, the offer for transmission to a communications device.

In some aspects, the artificial intelligence program comprises at least one genetic algorithm, step 602 stores the set of rules in the memory element, and step 604 generates, using the set of rules and the processor, a plurality of offers; and selects, using the at least one genetic algorithm and the processor, the offer from the plurality of marketing offers. In some aspects, step 606 outputs, via an interface element for the general-purpose computer, the offer for transmission to a communications device.

The following is a listing of exemplary tables that can be used in a present invention method or system. It should be understood that a present invention method or system is not limited to any or all of the tables shown and that other tables are included in the spirit and scope of the claimed invention.

```
Customer Table
  Customer ID
  Customer Personal Info
  Customer Billing Info
  Customer Cell Phone Info
  Loyalty Program Info
  Transaction History
  Type
  Class
  Offer History
Cashier Table
  Cashier ID
  Cashier Offer History
Transaction Table
  Transaction ID
  Date
  Transaction Information
  Customer ID
  Store ID
  Item ID 1-n
  Offer ID 1-n
  Offer Display ID 1-n
  Offer Accepted y/n
  Hardware type
  Payment Method
  People In Party
  Change Due
  Tax collected
Transaction Type Table
  Transaction Type ID
  Transaction Type Descriptor
Transaction Type Class Table
  Transaction Type Class ID
  Transaction Type Class Descriptor
Area Table
  Area ID
  Area Descriptor
Region Table
  Region ID
  Region Descriptor
Accept Status Table
  Status ID
  Transaction ID
  Status Code (e.g., accept, reject, replace, alternative, displayed, shown,
  not shown, etc.)
  Date
  Time
Activity Weights Table
  ID
  Code
  Weight Factor (amount/percent)
  Rule IDs 1-N
  Application Dates/Times
BioNet Calculated Periods Table
  Menu Item ID
  Alternative ID
    Period ID 1-N
BioNet Exclusion Sets Table
  ID
  Name
  Description
  Menu Item ID
  Rules ID 1-N
BioNet Exclusion Set Member Table
  Menu Item ID
  Exclusion Set ID
BioNet Min/Max Cost Table
  Menu Item ID
  Fixed Costs 1-N
  Variable Costs 1-N
  Other Costs 1-N
  Min Under Dollar Add Offer Price
  Min Over Dollar Add Offer Price
  Max Under Dollar Add Offer Price
  Max Over Dollar Add Offer Price
BioNet Offer Item Creator Programs Table
  Creator ID
  Name
  Rounding Percentage
  Value Of
BioNet Offer Pool Table
  Offer Pool ID
  Order/Transaction ID
  Menu Item ID
  Offer Price
  Score
  Polled
BioNet Offer Item Creators Table
  Creator ID
  Class Name
  Enabled y/n
  Usage Order/Sequence Number
BioNet Selection Strategies/Score Table
  Strategy ID
  Name
  Description
  Score
BioNet Offer Selection Strategy Table
  Strategy ID
  Name
  Description
  Strategies 1-N
  Grammar Version #
```

The following is a listing of exemplary strategy examples applicable to a present invention method or system. It should be understood that a present invention method or system is not limited to any or all of the strategies shown and that other strategies are included in the spirit and scope of the claimed invention.

| | |
|---|---|
| 1. | Order_Random_Both EXPLOIT Select Top Bucket EXPLORE Select All |
| 2. | Order_Random_Both EXPLOIT Select Top Bucket & Select Top Profit |
| | XPLORE Select All |
| 3. | Order_Exploit_Explore EXPLOIT Select Top Bucket EXPLORE < Random_Number |
| | 0.5 Select All Select Not_Bottom Bucket |
| 4. | AcceptRate 0.3 Order_Random_Both EXPLOIT Select Top Profit |
| | EXPLORE < Random_Number 0.5 Select All Select Not_Bottom Bucket |
| | Order_Random_Both EXPLOIT Select Top Bucket EXPLORE < Random_Number |
| | 0.5 Select All Select Not_Bottom Bucket |
| 5. | Order_Random_Both EXPLOIT > AcceptRate 0.3 Select Top Bucket & |
| | Select Top Profit Select Top AR EXPLORE < Random_Number 0.5 |
| | Select All Select Not_Bottom Bucket |

The following is a further listing of exemplary tables that can be used in a present invention method or system. It should be understood that a present invention method or system is not limited to any or all of the tables shown and that other tables are included in the spirit and scope of the claimed invention.

```
BioNet Specified Periods Table
    Menu Item ID
    Period ID
BioNet Offer Pool Size Table
    Order/Transaction ID
    Offer Pool Size
BioNet Parameters Table
    ID
    Name
    Description
    Application Rules 1 - N
    Value
Parameter Examples Table
    LogEnabled
    LogFileName
    RefreshTime
    RefreshRate
    ErrorFile
    LogOfferSize
    AntiDilutionFactor
    NumOffers
BioNet Strategy Score Descriptions Table
    Score ID
    Description
    Weight
    Rules 1 - N
```

The following examples are applicable to a present invention method or system. It should be understood that a present invention method or system is not limited to any or all of the examples shown.

| | |
|---|---|
| AcceptRate | 10 |
| OfferGenerationRate | 2 |
| ProfitRate | 7 |
| AverageCheckRate | 7 |
| AverageItemCountRate | 5 |
| ExplorationRate | 0 |
| Experience | 9 |
| Complexity | 1 |

The following is a further listing of exemplary tables that can be used in a present invention method or system. It should be understood that a present invention method or system is not limited to any or all of the tables shown and that other tables are included in the spirit and scope of the claimed invention.

```
Cashier Table
    ID
    Payroll ID
    Description
    Notes
Category Table
    ID
    Name
    Description
Configuration Database
    ConfigID
    Enabled
    AutoResumeTime
    RoundUpChange
    MaxOfferDisplay
    DisableTime
    PollDirectory
    StoreID
    PollingTime
    PollingIntervalCustomerID
    MaxOfferScroll
    MaxOrderOffers
    Master Observe
    SiteID
Destination Table
    ID
    Name
    Description
    Permission Rules 1 - N
    Restriction Rules 1 - N
Child Category Table
    Child Category ID
    Name
    Description
    Permission Rules 1 - N
    Restriction Rules 1 - N
Coupon Configuration Table
    CouponCfgID
    Description
    StartInDays
    ValidForDays
    StartDate
    ExpireDate
    TemplateFile
    LookupGuid
Error Table
    ErrorID
    ErrorNumber
    Description
    Type
    FileName
    LineNumber
    Hostname
    DTStamp
    MSec
Eliminate Category Table
    Rule ID
    Category ID
Point of Marketing Audit Trail Table
    AuditID
    AuditDate
    vcAuditAction
    vcAuditHostName
    vcAuditProgramName
    vcAuditNTUser
    vcAuditLogin
    vcTable
    BeforeData
    AfterData
    Polled y/n
Engine Module Table
    ModuleID
    ProgIDSequence
    Enable Description
    Param1
    Param2
    Param3
    Param4
    LookupGuid
```

The following examples are applicable to a present invention method or system. It should be understood that a present invention method or system is not limited to any or all of the examples shown.

### EXAMPLES

| | | | |
|---|---|---|---|
| 2 | Engines.SelectEngine | 1 | TRUE Menu Item Selection |
| | | | Engine |
| 3 | Engines.ScoreEngine | 2 | TRUE Assign a score to the |
| | | | offer items |
| 4 | Engines.SortEngine | 3 | TRUE Sort the offers by score |
| 5 | Engines.WeightedRandEngine | 4 | TRUE Weighted Randomization |
| 6 | Engines.LimitEngine | 5 | TRUE Limit the number of |
| | | | return offers |
| 7 | Engines.ForceOptions | 6 | FALSEForce Multiple Offer |
| | | | Type Options |

The following is a further listing of exemplary tables that can be used in a present invention method or system. It should be understood that a present invention method or system is not limited to any or all of the tables shown and that other tables are included in the spirit and scope of the claimed invention.

```
Item Cost Type Table
    Item Cost Type ID
    Name
    Description
```

The following examples are applicable to a present invention method or system. It should be understood that a present invention method or system is not limited to any or all of the examples shown.

| | |
|---|---|
| 1 | Food & Paper Cost |
| 2 | Food Cost |
| 3 | Paper Cost |
| 4 | Corporate Royalty |
| 5 | Corporate Advertising |
| 6 | Rent |
| 7 | Sales Tax |
| 8 | Incentives |
| 9 | Labor |

The following is a further listing of exemplary tables that can be used in a present invention method or system. It should be understood that a present invention method or system is not limited to any or all of the tables shown and that other tables are included in the spirit and scope of the claimed invention.

```
Item Cost Percentage Type Table
    Percentage Type ID
    Name
    Description
    Value
Item Cost Table
    ItemCostID
    MenuItemID
    Amount 1 - N
    Percentage 1 - N
    ItemCostTypeID 1 - N
    LookupGuid
    Rules 1 - N
Item Cost Type w/Percentage Type Table
    Item Cost ID
    Percentage Type ID
Link Category Table
    LinkCategoryID
    Name
    Description
    LookupGuid
    Rules 1 - N
Language Table
    Language ID
    Name
    Description
Media Package Table
    ID
    Name
    Description
    Submitted By
    Submitted On Time/Date
    Last Modified Time/Date/User ID
    Valid From Time/Date
    Valid Through Time/Date
    Application Rules 1 - N
Menu Item Table
    MenuItemID
    PeriodID
    Cost
    Price
    Description
    Min_Price
    Max_Price
    PrepTime
    Promotion
    ScreenID
    Enabled
    SDesc
    StockLevel
    CustomerCount
    CouponCfgID
    CouponType
Logical Template Table
    Template ID
    Name
    Description
    Template Entries 1 - N
Menu Item Link Table
    Link Category ID
    Menu Item ID
POS Menu Item/RDNA Menu Item Mapping Table/Link
    Menu Item ID
    RDNA Menu Item ID
    Additional Menu Item ID/Link Code
Menu Item Minimum Offer Price Table
    Menu Item ID
    Min Offer Price
Menu Item Category Table
    Category ID
    Menu Item ID
    Enable y/n
Menu Item Report Table
    MenuItemID
    PeriodID
    Amount
    Price
    Description
    Min_Price
    Max_Price
    PrepTime
    Promotion
    ScreenID
    Enabled
    CustomerCount
    Min_OfferPrice
    Max_OfferPrice
Menu Item Sell More/Sell Less Table
    Menu Item ID
    Sell More/Less/None
    Created On Time/Date/User ID
    Valid From Time/Date
    Valid Through Time/Date
    Quantity/Percentage
    Value
Menu Item Type Table
    Menu Item ID
    Description
```

The following examples are applicable to a present invention method or system. It should be understood that a present invention method or system is not limited to any or all of the examples shown.

| | |
|---|---|
| 1 | UPGRADE_TO |
| 2 | UPGRADE_FROM |
| 4 | ADD_ONLY |

The following is a further listing of exemplary tables that can be used in a present invention method or system. It should be understood that a present invention method or system is not limited to any or all of the tables shown and that other tables are included in the spirit and scope of the claimed invention.

```
Minimum Profit Table
    MinProfitID
    MenuItemID
    UpsellTypeID
    Description
    Amount
    Percentage
    LookupGuid
Number Word Map Table
    NumberWordMapId
    Description
    NumberWordMap
Menu Item With Type Table
    Menu Item Type
    Menu Item ID
Offer Coupon Table
    StoreID
    CouponCfgID
    StartDate/Time
    ExpireDate/Time
    Polled
    LookupGuid
Offer Generator Table
    Program  ID
    Name
    Description
    Enabled
Offer Item Table
    AcceptStatusID
    CategoryID
    MenuItemID
    OfferPrice
    Cost
    FixedCost
    DTStamp
    LookupGuid
    RuleID 1 - N
Offer Text Table
    Offer Text ID
    Language ID
    Text
    Rules 1 - N
Order Item Table
    ScreenID
    DestinationID
    CategoryID
    MenuItemID
    Price
    DTStamp
    LookupGuid
Order Table
    Order/Transaction ID
    DestinationID
    PeriodID
    RegisterID
    CashierID
    CustomerCount
    DTStamp
    LookupGuid
    Polled
Order Status Table
    Order/Transaction ID
    Description
    Status Code
Popularity Coefficient Table
    Popularity ID
    Score
    Coefficient
Day part Period Table
    ID
    Name
    Description
    Start Time
    End Time
RDNA Menu Item Alternative Descriptions Table
    RDNA Menu Item ID
    Name
    Description
    Offer Display Text
    Offer Display Graphic
    Display Rules 1 - N
    Additional Display Options
        Display ID 1 - N
        Display Text
        Display Graphic
        Display Rules 1 - N
POS Terminal Table
    Register ID
    Name
    Description
    Type
    Operated By (e.g., cashier, call center operator, end user,)
POS Terminal Uses/Limitations Rules Database
    Rule ID
    Applies To Register ID 1 - N
    Rules 1 - N
Register Deal Display Link Table
    Register ID
    Number/Word Map ID
Rounding Rules Database
    Rule  ID
    Name
    Description
    Rules 1 - N
    Lookup GUID
Rules Category Table
    Rule ID
    Rule Category ID
Rules for Order Table
    Rule ID
Rules for Menu Items Table
    Rule Id
    Menu Item ID and/or
    RDNA Menu Item ID
```

The following is a further listing of exemplary data bases that can be used in a present invention method or system. It should be understood that a present invention method or system is not limited to any or all of the databases shown and that other databases are included in the spirit and scope of the claimed invention.

```
Rules Database
    Rule ID
    Name
    Description
    Period ID
    Screen ID
    Enable y/n
    Upsell Type
    Enable y/n
    Lookup GUID
    Rules 1 - N
Screens Database
    Screen ID
    Name
    Description
    Screen
```

The following is a further listing of exemplary tables that can be used in a present invention method or system. It should be understood that a present invention method or system is not limited to any or all of the tables shown and that other tables are included in the spirit and scope of the claimed invention.

```
Store Contact Table
    Store ID
    Name
    Description
    Mailing Address
    Management Employee IDs 1 - N
    Crew Employee IDs 1 - N
    Contact Information
    IP address
    Email address 1 - N
Store Table
    Store ID
    Store Info
    Adjacent Stores 1 - N
    Region
    Class
    Type
Temporary Rules Table
    Rule ID
    Enable y/n
    Apply On Date/Time
    Valid Through Date/Time
    Submitted by User/Employee ID
    Applies To POS Terminal ID 1 - N
    Rules 1 - N
    Menu Item(s) 1 - N
Marketing Offer Type Table
    Offer Type ID
    Name
    Description
    Offer
User ID Table
    ID
    Name
    Security Level
    Access To 1 - N
    Denied Access To 1 - N
Version Information Table
    Version ID
    Version Name
    Release Number
    Release Notes ID
    Date Released
    Date Installed
    Installed By User ID
    Previous Version ID
    Valid On Time/Date
    Valid Through Time/Date
Weighting Factors Table
    Weight Factor ID
    Name
    Description
    Weight Value
    Weight Percentage
    Enable
    Additional Parameters 1 - N
    Application Rules 1 - N
```

The following example of table mapping is applicable to a present invention method or system. It should be understood that a present invention method or system is not limited to any or all of the examples shown.

POS - Point of Marketing System Table Mapping

```
POS Transaction ID
    RDNA Transaction ID
POS Log ID
    RDNA Log ID
```

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

### LISTING OF ELEMENTS/COMPONENTS

102 memory element
104 processor
105 specially programmed general-purpose computer
106 set of rules
107 RB portion
108 generating element, or function
110 selecting element, or function
112 artificial intelligence program
113 AI portion
114 plurality of executables
116 executable from the plurality of executables
118 interface element
202 processor
204 and interface element
206 specially programmed general-purpose computer
208 generating element, or function
210 marketing offer
212 set of rules
213 RB portion
214 artificial intelligence program
215 AI portion
216 at least one memory element
218 plurality of marketing offers
220 marketing offer
222 plurality of marketing offers
224 marketing offer
226 at least one respective algorithm
228 at least one respective algorithm
230 set of rules
232 plurality of marketing offers
234 marketing offer
236 at least one respective algorithm
238 at least one respective algorithm
240 plurality of marketing offers
242 plurality of marketing offers
244 marketing offer
246 set of rules
248 set of rules
250 plurality of marketing offers
252 plurality of marketing offers
254 marketing offer
256 order for an item
258 compiler element, or function
260 history of sales transactions
261 input
302 determining element, or function
304 processor
306 specially programmed general-purpose computer
308 interface element
310 order
312 offer
314 artificial intelligence program
316 set of rules
318 memory element
320 RB portion
322 AI portion
324 offer
326 plurality of offers
328 offer

What is claimed is:

1. A method for operating a business system, comprising the steps of:
storing, in a memory element of a specially programmed general-purpose computer, a set of rules;
generating, using a processor in said general-purpose computer and an artificial intelligence program, a plurality of executables;
selecting, using said processor and said set of rules, an executable from among said plurality of executables; and,
executing, using said processor and an interface element in said general-purpose computer, said executable.

2. The method of claim 1 wherein executing an executable further comprises outputting said executable for transmission to a communications device.

3. The method of claim 1 wherein said artificial intelligence program comprises at least one genetic algorithm.

4. A method for managing at least one of sales and marketing promotions, comprising the steps of:
generating a marketing offer using a set of rules, an artificial intelligence program, and a processor and at least one memory element in a specially programmed general-purpose computer; and,
outputting, using an interface element in said general-purpose computer, said marketing offer.

5. The method of claim 4 wherein said artificial intelligence program comprises at least one genetic algorithm and said method further comprising storing, in said at least one memory element, said set of rules and wherein generating a marketing offer further comprises:
generating, using said processor and said at least one genetic algorithm, a plurality of marketing offers; and,
selecting, using said set of rules and said processor, said marketing offer from said plurality of marketing offers, and wherein outputting said marketing offer further comprises outputting said marketing offer for transmission to a communications device.

6. The method of claim 4 wherein said artificial intelligence program comprises at least one genetic algorithm and said method further comprising storing, in said at least one memory element, said set of rules and wherein generating a marketing offer further comprises:
generating, using said set of rules and said processor, a plurality of marketing offers; and,
selecting, using said at least one genetic algorithm and said processor, said marketing offer from said plurality of marketing offers, and wherein outputting said marketing offer further comprises outputting said marketing offer for transmission to a communications device.

7. The method of claim 4 wherein said artificial intelligence program comprises at least one first and second genetic algorithms and wherein generating a marketing offer further comprises:
defining a set of rules using said at least one first genetic algorithm and said processor;
selecting, using said at least one second genetic algorithm and said processor, a plurality of marketing offers; and,
selecting, using said set of rules and said processor, said marketing offer and wherein outputting said marketing offer further comprises outputting said marketing offer for transmission to a communications device.

8. The method of claim 4 wherein said artificial intelligence program comprises at least one first and second genetic algorithms and said method further comprising storing, in said at least one memory element, said set of rules and wherein generating a marketing offer further comprises:
generating, using said at least one first genetic algorithm and said processor, a first plurality of marketing offers;
selecting, using said set of rules and said processor, a second plurality of marketing offers from said first plurality of marketing offers; and,
selecting, using said at least one second genetic algorithm and said processor, said marketing offer.

9. The method of claim 4 wherein said artificial intelligence program comprises at least one genetic algorithm and said method further comprising storing, in said at least one memory element, first and second sets of rules and wherein generating a marketing offer further comprises:
generating, using said first set of rules and said processor, a first plurality of marketing offers;
selecting, using said at least one genetic algorithm and said processor, a second plurality of marketing offers from said first plurality of marketing offers; and,
selecting, using said second set of rules and said processor, said marketing offer.

10. The method of claim 4 further comprising accepting an order for an item through said interface element and wherein generating a marketing offer further comprises generating said marketing offer in response to said order.

11. The method of claim 4 further comprising:
compiling, using said processor and said at least one memory element, a history of sales transactions by at least one of a customer, store, area, region, grouping of transaction types, and class of transaction types; and,
accepting, using said interface element, an input associated with said at least one of a customer, store, area, region, grouping of transaction types, and class of transaction types and wherein generating a marketing offer further comprises generating said marketing offer in response to at least one of said history of sales transactions and said input.

12. The method of claim 4 wherein generating a marketing offer further comprises generating said marketing offer in response to at least one of temporal information, personnel involved with said offer, a location associated with said offer, a weather condition, sales information associated with said offer, inventory information, a marketing or promotional campaign, change amount due, a method of payment, an available discount, a response to a previous offer, a response a previous offer to a given customer, type of customer, and class of customer.

13. The method of claim 4 wherein generating a marketing offer further comprises selecting a content of said marketing offer and a sensory presentation for said offer.

14. The method of claim 4 further comprising receiving an order via an interface element for a specially programmed general-purpose computer and wherein generating a marketing offer includes generating the marketing offer in response to the order.

15. A system for operating a business system, comprising:
a memory element of a specially programmed general-purpose computer including a set of rules;
a generating element in a processor for said general-purpose computer arranged to generate, using an artificial intelligence program, a plurality of executables;
a selecting element in said processor arranged to select, using said set of rules, an executable from among said plurality of executables; and,
an interface element in said general-purpose computer arranged to output, using said processor, said executable.

16. The system of claim 15 wherein said artificial intelligence program comprises at least one genetic algorithm.

17. The system of claim 15 wherein said interface element is arranged to output said executable for transmission to a communications device.

18. A system for managing at least one of sales and marketing promotions, comprising:
a generating element in a processor for a specially programmed general-purpose computer arranged to generate a marketing offer using a set of rules, an artificial intelligence program, and at least one memory element in said general-purpose computer; and,
an interface element in said general-purpose computer arranged to output said marketing offer.

19. The system of claim 180 wherein said artificial intelligence program comprises at least one genetic algorithm, said memory element includes said set of rules, and said generating element is arranged to:
generate, using said at least one genetic algorithm, a plurality of marketing offers; and,
select, using said set of rules, said marketing offer from said plurality of marketing offers, and wherein said interface element is arranged to output said marketing offer for transmission to a communications device.

20. The system of claim 18 wherein said artificial intelligence program comprises at least one genetic algorithm, said memory element comprises said set of rules, and said generating element is arranged to:
generate, using said set of rules, a plurality of marketing offers; and,
select, using said at least one genetic algorithm, said marketing offer from said plurality of marketing offers, and wherein said interface element is arranged to output said marketing offer for transmission to a communications device.

21. The system of claim 18 wherein said artificial intelligence program comprises at least one first and second genetic algorithms and said generating element is arranged to:
define a set of rules using said at least one first genetic algorithm;
select, using said at least one second genetic algorithm, a plurality of marketing offers; and,
select, using said set of rules, said marketing offer and wherein said interface element is arranged to output said marketing offer for transmission to a communications device.

22. The system of claim 18 wherein said artificial intelligence program comprises at least one first and second genetic algorithms, said memory element comprises said set of rules, and said generating element is arranged to:
generate, using said at least one first genetic algorithm, a first plurality of marketing offers;
select, using said set of rules, a second plurality of marketing offers from said first plurality of marketing offers; and,
select, using said at least one second genetic algorithm, said marketing offer.

23. The system of claim 18 wherein said artificial intelligence program comprises at least one genetic algorithm, said at least one memory element comprises first and second sets of rules, and wherein said generating element is arranged to:
generate, using said first set of rules, a first plurality of marketing offers;
select, using said at least one first genetic algorithm, a second plurality of marketing offers from said first plurality of marketing offers; and,
select, using said second set of rules, said marketing offer.

24. The system of claim 18 wherein said interface element is arranged to accept an order for an item and wherein said generating element is arranged to generate said marketing offer in response to said order.

25. The system of claim 18 further comprising a compiler element in said processor arranged to store in said at least one memory element, a history of sales transactions by at least one of a customer, store, area, region, grouping of transaction types, and class of transaction types, wherein said interface element is arranged to accepting an input associated with said at least one of a customer, store, area, region, grouping of transaction types, and class of transaction types and wherein said generating element is arranged to generate said marketing offer in response to one of said history of sales transactions and said input.

26. The system of claim 18 wherein said generating element is arranged to generate said marketing offer in response to at least one of temporal information, personnel involved with said offer, a location associated with said offer, a weather condition, sales information associated with said offer, inventory information, a marketing or promotional campaign, change amount due, a method of payment, an available discount, a response to a previous offer, a response a previous offer to a given customer, type of customer, and class of customer.

27. The system of claim 18 wherein said generating element is arranged to select a content of said marketing offer and a sensory presentation for said offer.

28. The system of claim 18 wherein in response to receiving an order via the interface element the generating element generates the marketing offer.
